(19) United States
(12) Patent Application Publication
(10) Pub. No.: US 2004/0054747 A1
(43) Pub. Date: Mar. 18, 2004

(54) Pervasive home network appliance

(75) Inventors: Jochen Breh, Marbach (DE); Gerd Breiter, Wildberg (DE); Hendrik Wagner, (US)

Correspondence Address: Mark E. McBurney, Intellectual Property Law Dept., IBM Corporation, 11400 Burnet Road, Austin, TX, 78758, US

(73) Assignee: International Business Machines Corporation, Armonk, NY

(21) Appl. No.: 10/242,255

(22) Filed: Sep. 12, 2002

(51) Int. Cl. G06F 15/16

(52) U.S. Cl. 709/208

(57) ABSTRACT

According to the present invention a Pervasive Home Network Appliance (appliance) is provided for controlling of home devices in a home network, whereby such appliance may also be accessed automatically or via an additional interface, such as by a cellular (mobile) phone or an Internet browser. The pervasive home network appliance may be implemented by a method and an appliance for facilitating communication between a user interface and one or more external devices. The appliance comprises at least one control adapter for transforming a particular communication protocol to be established between the user interface and at least one of the control adapters, one or more device adapters for transforming a particular communication protocol to be established between one of the external devices and the respective one of the device adapters and a routing engine for routing messages being produced by one of the control adapters to the appropriate one of the device adapters.

### CROSS REFERENCE TO RELATED APPLICATIONS

The present invention is related to the subject matter of the following commonly assigned copending U.S. patent application, “Pervasive Home Network Portal”, having Ser. No. ________, docket no. DE9-2001-101, and filed concurrently herewith.

### BACKGROUND OF THE INVENTION

1. Field of the Invention

The present invention generally relates to a method and an apparatus for communicating to at least one electronic device. Particularly, the present invention relates to a method and a pervasive home network appliance for making different pervasive home network devices accessible via one or more standardized interfaces.

2. Description of the Related Art

In the last few years there could be noticed a desire for an extension of home automation. Together with the increasing networking and wireless communication technology the technical vision of a smart home controlled via the Internet now seems to be more realistic than ever before. Affordable wireless devices may build the backbone of smart homes. Another positive factor is the high percentage of private homes already having access to the Internet.

The so-called smart home contains sensors like temperature feelers, movement alarm units and even video cameras. These devices pass their data to a control device, which in turn controls actuators such as heating, shutters, lawn sprinkler, etc. If applicable, the control unit sends notifications via new communication media, such as cell-phone, e-mail or pager to the users. The sensors may even be placed far away from the home device to be controlled.

From U.S. Pat. No. 6,098,893 by Ulf Stefan Berglund et. al., assigned to Honeywell Inc., Minneapolis, Minn., USA, filed Oct. 22, 1998, issued Aug. 8, 2000, “Comfort control system incorporating weather forecast data and a method for operating such a system” a comfort control system for multiple buildings is known (whether residential, commercial or industrial). In such a system, a weather forecast unit sends weather forecast data over the Internet to a building management provider which handles building management services for a number of clients, each having a number of buildings and properties. At the provider's reception station, data on the external-building characteristics of all the buildings are compiled with the received data and then fed to the appropriate building management controls system.

However, the control of home devices is not limited to use with weather forecasts from a central data source and external building information to feed building management control systems. A typical household contains several home devices. Home devices are often controlled using a single common control unit, namely a remote control device. This single common control unit allows a homeowner to control and command several different home devices using a single interface. Thus, many manufacturers have developed control units for controlling and commanding their home devices from a single interface.

One drawback associated with using the remote control unit to command and control home devices is that it provides static control and command logic for controlling and commanding each home device. Therefore, a particular remote control unit can only control and command those home devices for which it includes the necessary control and command logic. For example, if a remote control unit comprises logic for controlling a television (TV), a video cassette recorder (VCR), and a digital video device, but not a compact disk (CD) unit, the remote control unit can not be used to command and control the CD unit. In addition, as new home devices are developed, the remote control unit will not be able to control and command the new home devices that require control and command logic that was not known at the time the remote control unit was developed.

Therefore, U.S. Pat. No. 6,198,479 by Richard James Humpleman et. al, assigned to Samsung Electronics Co., LTD, Suwon, Republic of Korea, filed Jun. 24, 1998, issued Mar. 6, 2001, “Home network, browser based, command and control” suggests a method and system for commanding and controlling diverse home devices on a home network to perform a service. According to the method, a client device that is capable of displaying a user interface is connected to a home network. A software agent is executed on the client device to cause a user interface to be displayed on the client device. First and second home devices connected to the home network are selected from the user interface, and control and command data are sent from the client device to the first and second home devices to cause these devices to communicate with each other to perform the service.

Thus, each device has to provide HTTP (Hypertext Transfer Protocol) and TCP/IP (Transmission Control Protocol over Internet Protocol) functionality. However, this might add a severe complexity to each device which may not be acceptable in certain cases.

U.S. Pat. No. 5,956,487 by Chandrasekar Venkatraman et. al., assigned to Hewlett-Packard Company, Palo Alto, Calif., USA, filed Oct. 25, 1996, issued Sep. 21, 1999 “Embedding web access mechanism in an appliance for user interface functions including a web server and web browser” teaches how web access functionality is embedded in a device to enable low cost widely accessible and enhanced user interface functions for the device. A web server in the device provides access to the user interface functions for the device through a device web page. A network interface in the device enables access to the web page by a web browser such that a user of the web browser accesses the user interface functions for the device through the web page. Again web access functionality is embedded in each device.

In the White Paper “The Connected Home Powered by Java Embedded Server Software” by Sun Microsystems, Inc., Palo Alto, Calif., USA, 2001, a connected home is described. It connects all of the networks that already exist in the home—electrical, telephone, wireless—and then connect each one with any number of external networks via the Internet. This is done using a home gateway that could be a cable modem, a set top box, a DSL modem, a web phone or a dedicated residential gateway device. The specialized hardware and software required for a gateway can be built into a new, specialized device or embedded into an existing device. In effect, adding an embedded server—a special-purpose, low-memory, software server (not a Web server)—to any broad band termination device, transforms it into a home gateway. Preferably, a Java Embedded Server and Java enabled devices are employed.

Yet again, web access functionality is embedded in each device, i.e., in order to implement a connected home as described every single device needs to be Java enabled. Thus, the object of the present invention is to provide an improved method and appliance for communicating to at least one electronic device.

### BRIEF SUMMARY OF THE INVENTION

The foregoing object is achieved by a method and an apparatus as laid out in the independent claims. Further advantageous embodiments of the present invention are described in the dependent claims and are taught in the following description.

According to the present invention a method and an apparatus is provided for facilitating communication between a user interface and one or more external devices. The apparatus includes at least one control adapter for transforming a particular communication protocol to be established between the user interface and the control adapter, one or more device adapters for transforming a particular communication protocol to be established between one of said external devices and the respective one of the device adapters and a routing engine for routing messages being produced by one of the control adapters to the appropriate one of the device adapters.

The method for facilitating communication between an user interface and one or more external devices to be used with an apparatus as described above includes the following steps. First said control adapter receives from the user interface a command for controlling the external device. Then, the control adapter translates the device command into a message having a format the routing engine is able to interpret. Subsequently, the routing engine receives the message and performs a look up in order to find the appropriate device adapter. Then it sends the message to the device adapter. Thereafter, the device adapter translates the message into a device control string having a format that can be processed by the device, and, finally, it sends the device control string to the device itself.

In other words, according to the present invention an apparatus, also referred to as an appliance or Pervasive Home network Appliance (appliance) is provided for controlling of home devices in a home network, whereby such appliance may also be accessed automatically or via an additional interface, such as by a cellular (mobile) phone or an Internet browser. Home network devices, as used herein, includes any facility network device, such as factory or industrial control devices including gauges, valves, or the like.

The Pervasive Home Network Appliance may be an out-of-the-box server, such as a standard PDA (Personal Digital Assistant) like a Palm PDA by Palm, Inc. or a PSION PDA by Psion with a standard touch screen, i.e., an input device that allows a user to interact with the computer by touching the display screen. The input device would act as a user interface and would interact with a controller for devices, e.g., a heating control unit, connected to it via a (in most cases wireless) plug-and-play protocol, such as BlueTooth. The latter devices are referred to as Pervasive Home Network Devices (pervasive home network Devices).

The server may be used by clients from within or outside a location, e.g., a building, in which the pervasive home network Appliance is installed. Such clients, referred to as Pervasive Home Networking Clients (PHN Clients) may, e.g., be cellular (mobile) phones, applications located in the Internet, such a Pervasive Home Network Device Portal (as described in cross-referenced U.S. patent application “Pervasive Home Network Portal”, Docket no. DE9-2001-0101, filed concurrently herewith), or applications running on the pervasive home network Appliance itself.

The communication link between the appliance and the pervasive home network Clients may be a TCP/IP (Transmission Control Protocol over Internet Protocol) based request and reply protocol similar to HTTP (Hypertext Transfer Protocol). The interface to the various pervasive home network Devices on the other hand may be an asynchronous message based protocol using for example XML data formats implemented on top of transport protocols like IrDA (a Standard of the Infrared Data Association) and BlueTooth.

Besides of serving requests of the pervasive home network Clients and controlling the connected pervasive home network Devices, the pervasive home network Appliance may be a standard application server such as a Palm PDA by Palm, Inc., a PSION PDA by Psion or a Linux PDA for applications running on ‘light’ operating systems like PalmOS by Palm, Inc., EPOC (an operating system by PSION) or Linux.

The pervasive home network Appliance contains basically a server kernel and at least a first and a second interface. The first interface provides an communication link to the pervasive home network Client, i.e., the pervasive home network Client Interface, and the second interface provides an communication link to the pervasive home network Device, i.e., the pervasive home network Device interface.

The pervasive home network Client interface allows controlling of the pervasive home network appliance in various ways. For example a control adapter may facilitate a communication connection to a Pervasive Home Network Portal (this portal may be implemented based on an invention as disclosed in the cross-referenced U.S. patent application DE9-2001-0101, “Pervasive Home Network Portal”). Such a communication connection to an Internet Portal for controlling all pervasive home network devices advantageously provides high level control possibilities. Furthermore, another control adapter may be implemented to provide Cell Phone Support which guarantees high flexibility for controlling and monitoring pervasive home network Devices.

A further advantage of the pervasive home network Appliance is the possibility to extend the functionality of the interfaces by adding customer implemented plugins. In case of a missing functionality, users are able to install new plugins. Such plugins may be provided by manufacturers of particular pervasive home network Devices that should be enabled for remote control. These plugins may be added by down loading from the Internet, or other external data source, such as diskette, CD-ROM, or the like.

The server, located between the interfaces, has the following tasks:

Routing pervasive home network Client requests to the corresponding pervasive home network Devices

Routing the pervasive home network Device replies back to the requesting pervasive home network Client

Holding a list of active pervasive home network Devices

Routing pervasive home network Device events to the registered pervasive home network Clients

In order to facilitate the usage of the pervasive home network Appliance in multiple nonproprietary ways, in accordance to the present invention, a universal open architecture building a base for various extensions gets established. This advantageously also allows proprietary pervasive home network devices to be connected to the pervasive home network Appliance. It is acknowledged that according to the present invention, all devices may be controlled via various pervasive home network Clients, since on the client side of the pervasive home network Appliance extensions are provided, as well.

In the following section a brief overview of the principal functions of the appliance's interfaces are given. The client interface may be implemented as a request/reply pair based protocol. The following request types are advantageously defined. The command ‘Show Devices’ causes the server to return a list of connected devices. It should be noted that all listed pervasive home network Devices are able to receive commands, i.e., be controlled and monitored.

The command ‘Send Command’ initiates command data, e.g., XML data, to be sent to a specified pervasive home network device, specified, e.g., by a Device identifier (Device ID). After submitting the ‘Send Command’ the pervasive home network Appliance may asynchronously wait for the XML data returned by the pervasive home network device and sends this data reply back to the requesting pervasive home network Client.

The command ‘Register Event’ that launched a method according to which the pervasive home network Client registers for a particular event specified by an event identifier (Event ID) and the Device ID. The pervasive home network Appliance holds this registration in a persistent subscription list. It returns a registration acknowledgment. Whenever a pervasive home network Device raises an event (alarm), the pervasive home network Appliance sends a Send Event Request to all pervasive home network Clients registered for that specific event.

The command ‘Send Event’ gets sent by the pervasive home network Appliance to all pervasive home network Clients registered for that specific event. The pervasive home network Client replies with an event acknowledgment.

The command ‘Deregister Event’ invokes a pervasive home network Client to be deleted from the persistent subscription list by the pervasive home network Appliance. It returns a deregister acknowledgment.

The interface to the pervasive home network Devices may be an asynchronous message based protocol using for example XML data formats implemented on top of transport protocols like IrDA and BlueTooth. The following messages may be defined.

The message ‘Registration Broadcast’ which is sent by the pervasive home network Appliance to all pervasive home network Devices. If a pervasive home network Device is not already registered, it returns a ‘Register Device’ message. With the ‘Register Device’ message the pervasive home network Device registers itself to the pervasive home network Appliance, which in turn returns an unique Device ID to the particular device.

Furthermore, the message ‘Check Device’ may be sent by the pervasive home network Appliance to a specific pervasive home network Device repeatedly. When the pervasive home network Device returns an acknowledgment, the pervasive home network Appliance flags the pervasive home network Device as ‘active’, so a pervasive home network Client can send commands to the specific pervasive home network Device.

The message ‘Send Command’ is used by the pervasive home network Client to initiate the pervasive home network Appliance to check, whether or not the pervasive home network Device flag as set to ‘active’. If yes, the data of the ‘Send Command’ request may be copied to the ‘Send Command’ message, which in return is sent to the specific pervasive home network Device. When the pervasive home network Device returns a reply message, the data is copied to the ‘Send Command’ reply by the pervasive home network Appliance and sent back to the appropriate pervasive home network Client.

Finally, the message ‘Send Event’ is used, e.g., in case of an alarm. The pervasive home network Device will send a ‘Send Event’ message to the pervasive home network Appliance asynchronously. The pervasive home network Appliance checks, which pervasive home network Client has registered itself for that specific event and sends a ‘Send Event’ request to the appropriate pervasive home network Client.

The following scenario depicts a sequence of events that demonstrates an embodiment of a pervasive home network Appliance installation. First of all a pervasive home network Device, e.g., a thermometer, gets installed. Then, the pervasive home network Appliance sends a ‘Registration Broadcast’ from time to time. Now any pervasive home network Device receiving this broadcast can register itself to the pervasive home network Appliance if it is not already registered. During the registration a pervasive home network Device gets an unique Device ID. Subsequently, a pervasive home network Client (e.g. the pervasive home network Application installed on the pervasive home network Appliance) can send a ‘Send Command’ to the pervasive home network Device for querying the temperature. If the pervasive home network Appliance is connected to the phone line the querying of the temperature may be done via a web-service, offered within the Internet. In this case the web-service acts like a pervasive home network Client to the pervasive home network Appliance. Due to the open architecture of the pervasive home network Appliance, both on the pervasive home network Client side and on the pervasive home network Device side, it is possible for the user to combine any pervasive home network Devices with all offered pervasive home network Client (applications).

In case a user wants to control a Pervasive Home Network Appliance via the Internet, it can be registered at a so called Pervasive Home Network Portal. The user defines the telephone number, which can be used by the portal to establish a connection to his Pervasive Home Network Appliance. So it is possible for him to query all of his connected Pervasive Home Network Devices and to control them, respectively.

On the other hand it is possible for the Pervasive Home Network Appliance to send events asynchronously to the Pervasive Home Network Portal, which in turn can reroute the appropriate information via a publish/subscribe mechanism to the user. For a description of the publish/subscribe mechanism, see observer model in ‘Design Patterns’, Gamma, Helm et al., Addison Wesley, 1997. So if the user registers an event at the portal by specifying his e-mail address, the portal can send an e-mail in case the event occurs at home. For example, if the room temperature rises over a certain limit during summer, he can be informed via an e-mail. So he is able to close his shutters by using the Pervasive Home Networking Portal. In case of urgent events, the user can be informed via SMS, Voice Mail, etc., too.

Since the Pervasive Home Network Appliance is connected to multiple Pervasive Home Network Devices, it is obvious to implement an overall controlling application running on the appliance. When this application tends to be too complex, it is easy with this invention to move the control algorithm to the Internet by placing it into the Pervasive Home Network Portal. So these control algorithms represent typical web services within an e-utility environment with the possibility to raise usage fees.

The Cell Phone Support allows a connection to be established to the pervasive home network appliance. Controlling the pervasive home network appliance can be done by DTMF code sequences similar to a remote query of an answer machine. This functionality can be used for example to open a door in case of a lost key.

The above, as well as additional objectives, features and advantages of the present invention, will be apparent in the following detailed written description.

### BRIEF DESCRIPTION OF THE SEVERAL VIEWS OF THE DRAWINGS

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 shows a general block diagram that illustrates a system in which the present invention is being used;

FIG. 2 shows a detailed block diagram of an embodiment of the present invention;

FIG. 3 shows a flowchart illustrating a method of querying digital information within devices connected to the appliance in accordance with the present invention;

FIG. 4 shows a flowchart illustrating a method of setting digital information within devices connected to the appliance in accordance with the present invention;

FIG. 5 shows a flowchart illustrating a method of registering events as well as processing events by the appliance in accordance with the present invention;

FIG. 6 shows a flowchart illustrating a method of adding a new device adapter in accordance with the present invention; and

FIG. 7 shows a flowchart illustrating a method of detecting a devices added to the network in accordance with the present invention.

### DETAILED DESCRIPTION OF THE INVENTION

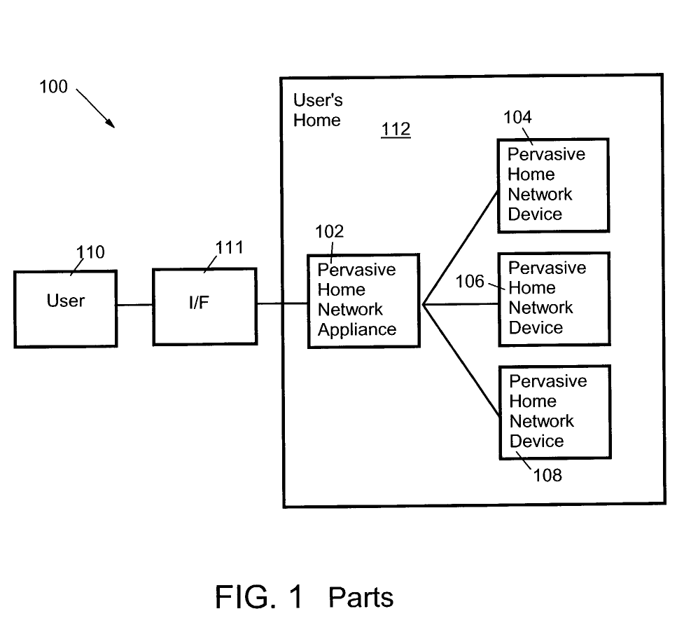

With reference now to FIG. 1, there is depicted a general block diagram which illustrates a system 100 in which a Pervasive Home Network Appliance 102 according to the present invention is being used. The system includes, first of all, the Pervasive Home Network Appliance 102 and, furthermore, three pervasive home network devices 104, 106, 108, a user 110, a user interface 111 and a home 112 of the user 110. It is acknowledged that the number of pervasive home network devices, homes, users and pervasive home network appliances may be different. Systems having two users caring for one or more homes having each at least one pervasive home network device are possible as well as any other combination.

The pervasive home network appliance 102 and the three pervasive home network devices 104 to 108 are depicted as being located inside the user's home 112. However, they may also be located outside the house as long as they are in an area in which it is possible to establish a communication link between one of the home network devices 104 to 108 and the pervasive home network appliance 102. On one hand, the pervasive home network devices 104 to 108 may be formed by sensors, such as, temperature feelers, movement alarm units and even video cameras. On the other hand, they may be formed by control devices (actuators), such as environmental control units including a heating unit, A/C, window shutters, a lawn sprinkler or the like. Further, home network devices may also include kitchen appliances, electronic devices such as stereos, TVs, VCRs, DVD players, spa controls and the like

The user 110 is in a position to check or control the pervasive home network devices via the user interface 111 and the pervasive home network appliance. The user interface may be formed by a text based or a graphical user interface which may be realized in various ways, such as, by the use of a mobile device, e.g., a cellular phone, or the Internet. The user is enabled either to query the devices 104 to 108 or to control such devices by sending appropriate device commands. A connection may be established in various ways, such as by using a mobile phone or the Internet.

Correspondingly, the devices 104 to 108 are configured to establish a communication link to the pervasive home network appliance 102 in various ways, too, such as by using infrared radiation, e.g., according to one of the IrDA (Infrared Data Association) standards, BlueTooth, i.e., a specification for short-range radio links between portable devices, twisted pair cable, i.e., a type of cable in which pairs of conductors are twisted together to randomize possible cross-talk from nearby wiring, or power line technology.

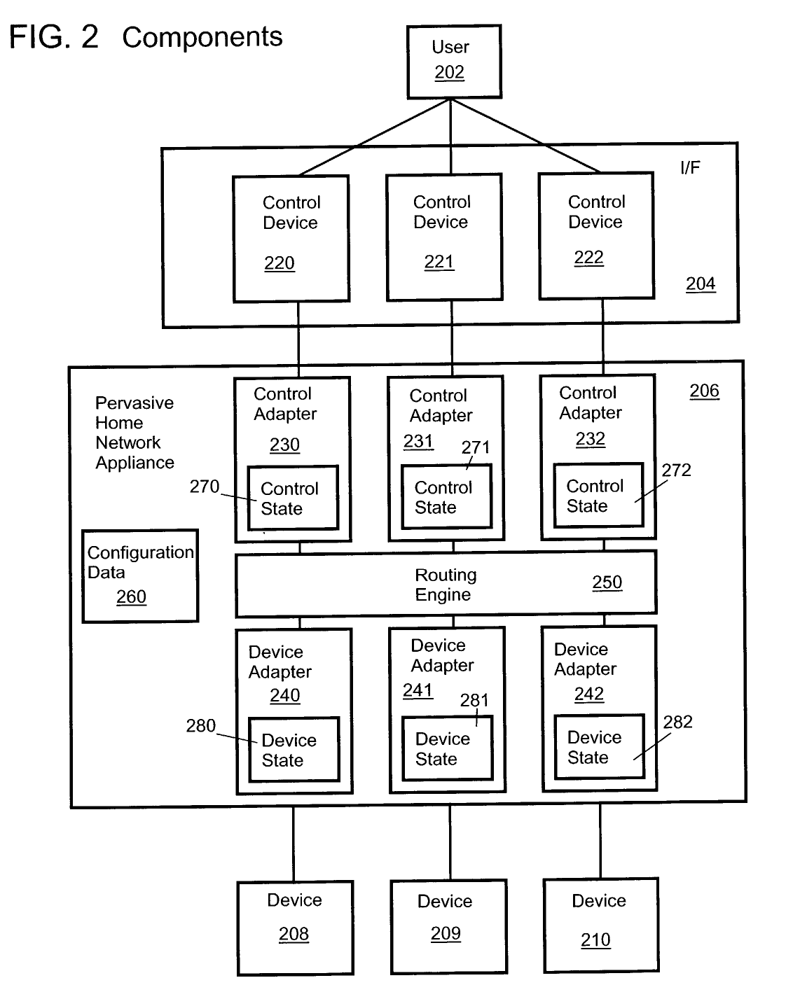

With reference to FIG. 2, there is depicted a detailed block diagram of an embodiment of the present invention. FIG. 2 shows the parts of the system, namely, a user 202, an user interface 204, a pervasive home network appliance 206 (appliance) and three pervasive home network devices 208, 209, 210 (devices), as explained above, and the components therein. The user 202 is able to establish a connection to the appliance in various ways that are provided by the user interface 204. The user interface may be formed by one or more control devices 220, 221, 222 which allow different ways of establishing a connection to the pervasive home network appliance. The control devices 220, 221 and 222 may be formed, e.g., by an Internet web browser connected to the Internet via a HTTP (Hypertext Transfer Protocol) connection, a mobile phone via a WAP (Wireless Application Protocol) connection or even a PDA (Personal Digital Assistant) via a wireless network connection, to send device commands to the devices.

The appliance 206 comprises the following components: three control adapters 230, 231 and 232, three device adapters 240, 241 and 242, a routing engine 250 and configuration data storage 260. Each control adapter 230, 231, 232 is connected to one of the control devices 220 to 222, respectively. The control adapters 230, 231, 232 are configured to perform the translation of a particular communication format being established between one of the control devices 220, 221, 222 and the respective control adapter 230, 231, 232. The particular communication formats may be formed by, e.g., HTTP requests, HTML (Hyper Text Markup Language) replies into a common message format, such as an XML based message format.

Similarly, the device adapters 240, 241, 242 are responsible for translating a communication format being understood by the respective device 208, 209, 210 into a common message format. In most cases the communication formats being understood by the respective devices 208 to 210 is most likely formed by a proprietary communication format, such as the RC5 infrared Protocol used in consumer electronic devices. Hence, the translation of such custom formats to the common format being used within the pervasive home network appliance is performed by the device adapters 240, 241, 242. In order to allow a communication between the device adapters 240, 241, 242 to the respective device 208, 209, 210 a communication link is established as explained above. In case an infrared communication link is being used, the device adapter may convert a RC5 infrared code into an XML based message format.

The routing engine 250 is on one hand connected to the control adapters 230, 231, 232 and on the other hand to the device adapters 240, 241, 242. It basically functions as a mediator between the control adapters 230, 231, 232 and the device adapter 240, 241, 242. The routing engine 250 is configured to route messages that are produced by one of the control adapters 230, 231, 232 to the appropriate one of the device adapters 240, 241, 242. On the other hand, the routing engine 250 is able to route messages generated by one of the device adapters 240, 241, 242 to the respective one of the control adapters 230, 231, 232.

In order to be able to route the messages correctly, the appliance 206 holds configuration data in the configuration data storage 260. Such configuration data specify the configuration of the appliance, such as the phone number the appliance needs for connecting itself to the Pervasive Home Network Portal.

Configuration data may be implemented, e.g., by using a file containing an XML document. Within the XML document an identification and a description of all provided control adapters 230, 231, 232 and device adapters 240, 241, 242 is stored.

Each control adapter 230, 231, 232 is configured to manage a control state that is kept in a control state storage 270, 271 and 272 one of which is being provided in each control adapter 230, 231, 232, respectively. Having a control state it is advantageously possible not only to change the format of a communication protocol, but also the communication protocol itself. For example, the HTTP/HTML protocol is synchronous, whereas the message protocol defined by the routing engine 250 is asynchronous. Synchronous means in this case, that a requester has to wait until a reply is received, so the requester is blocked during the wait interval (this is the case when a HTML browser waits for a web server). However, when using an asynchronous message protocol, the requester can send multiple requests simultaneously without being blocked, but it has to be able to map the reply to the original request, since the replies can arrive in an order other than the one in which the requests have been sent.

Correspondingly, each device adapters 240, 241, 242 is configured to manage a device state that is kept in a device state storage 280, 281 and 282 one of which is being provided in each device adapter 240, 241, 242, respectively. Hence, the device adapters 240, 241, 242 get advantageously enabled to transform, e.g., proprietary synchronous communication protocols into, e.g., asynchronous message protocols defined by the routing engine 250. Both states, the control state and device state information may be implemented, e.g., by using an XML document. The home network appliance of the present invention may be updated by adding control and device adapters from external data sources, such as the Internet, diskette, CD-ROM, or the like.

The routing engine 250 may be implemented as an ‘endless’ loop, querying or polling the control adapters 230, 231, 232 and the device adapters 240, 241, 242, respectively, for available messages. In case one of the control adapters 230, 231, 232 has a message, the routing engine 250 routes the message to the appropriate one of the device adapters 240, 241, 242. If one of the device adapters 240, 241, 242 has a message, the routing engine 250 determines the event encoded in that message and routes the message to all control adapters 230, 231, 232, which had registered themselves for that specific event at previous point in time. For a description of the publish/subscribe mechanism, see observer model in ‘Design Patterns’, Gamma, Helm et al., Addison Wesley, 1997.

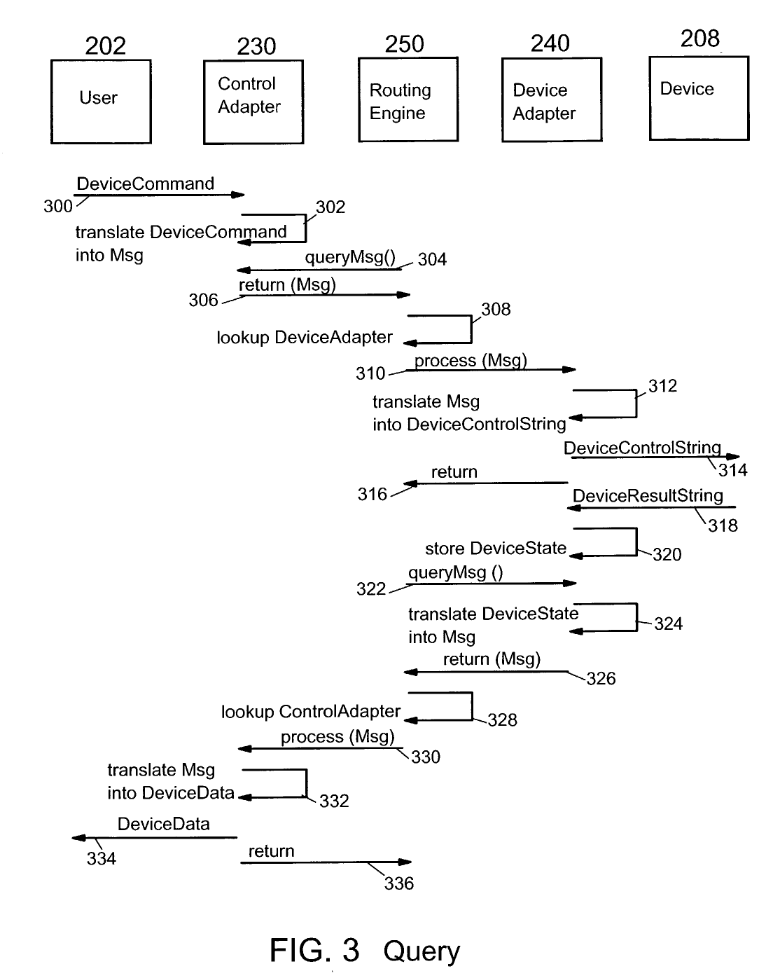

With reference now to FIG. 3, there is depicted a flowchart illustrating a method of querying digital information within devices connected to the appliance in accordance with the present invention. In this example, the communication takes place between the user 202, one of the control adapters 230, 231, 232, the routing engine 250, one of the device adapters 240, 241, 242 and the respective device 208, 209, 210. For clarity reasons, in this illustration the communication through the respective control device is not explicitly shown.

Whenever a user wants to retrieve values of one of his devices, he contacts the control adapter by sending a device command containing a respective query (arrow 300). A device command can for example be formed by an XML-document containing required information to address the respective device and specify the information to be retrieved. As indicated above a control device may function as a user-machine-interface generating the actual device command derived from the user's actions, such as selections on a GUI (Graphical User Interface) screen.

In response, the control adapter checks the device command and translates it into a message format the routing engine is able to interpret (arrow 302). Subsequently, the control adapter holds the translated message until it gets connected to the routing engine at a later point in time.

Regularly, the routing engine contacts the control adapter and queries whether or not there are one or more messages waiting to be processed (arrow 304), e.g., the control adapter has to deliver a message. In case there is a message waiting, as assumed in the present scenario, the control adapter transmits the previously translated message to the routing engine as a return message to the routing engine's query (arrow 306). The routing engine now examines the message, in particular by reading out the control information, and performs a lookup to find the appropriate adapter where the message is to be sent (arrow 308). In a preferred embodiment, the control adapter encoded the respective device adapter as the addressee within the message header. In the following, the routing engine sends the message to the device adapter specified by the examined target address (arrow 310).

After receiving the message, the device adapter translates the message into a format that can be processed by the device (arrow 312). In most cases the format may be formed by proprietary device control strings which might not even follow any commercial standard. However, since the device adapter is particularly configured to translate the received message in the format required by the device, basically any format may be supported. Then, the translated message, i.e., the device control string, is sent to the device (arrow 314). After sending the device control string to the device, the device adapter returns control back to the routing engine (arrow 316).

Asynchronously to the operation of the device adapter or the routing engine, the device sends a result message back to the device adapter (arrow 318). The result message may be in a particular proprietary format containing the requested information which might not even follow any commercial standard. However, the device adapter, that is particularly configured to deal with such format, interprets this device result string and extracts device state information from the device result string and stores such information (arrow 320).

The next time the device adapter is polled by the routing engine (arrow 322), the device adapter translates the device state information into a message having a format the routing engine is able to interpret (arrow 324) and returns such message (arrow 326). Subsequently, the routing engine examines the message and performs a lookup to find the appropriate adapter where the message is to be sent (arrow 328). Since the device adapter has encoded the control adapter as the addressee within the message header, the routing engine is enabled to send the message to the respective control adapter (arrow 330).

Thereafter, the control adapter translates the message into specific Device Data, such as an XML-Message containing, for example, the actual temperature measured by a thermometer device, presents the message and data to the user and returns control back to the routing engine (arrow 332, 334, 336).

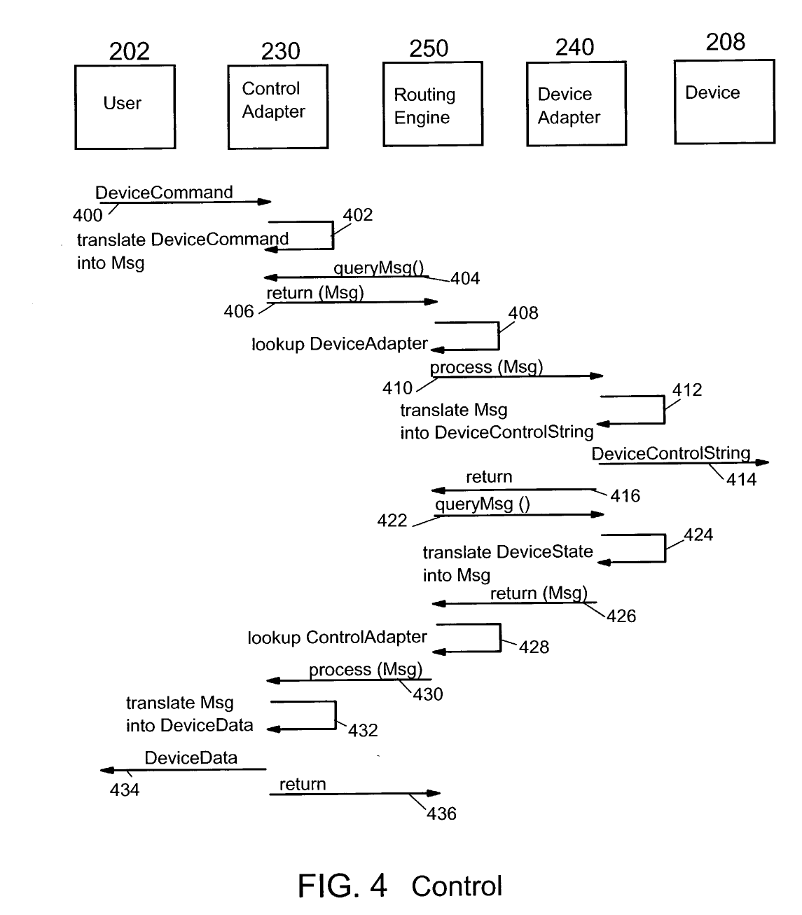

With reference now to FIG. 4, there is depicted a flowchart illustrating a method of setting digital information within devices connected to the appliance in accordance with the present invention. In this scenario, the communication takes place between the user 202, one of the control adapters 230, 231, 232 the routing engine 250, one of the device adapters 240, 241, 242 and the respective device 208, 209, 210. For clarity reasons, in this illustration the communication through the respective control device is not explicitly shown.

Whenever a user wants to control one of the devices, contact is made to the control adapter by sending a device command containing one or more new commands to be executed by the device or values to be set (arrow 400). A device command can for example be formed by an XML-document containing the required information to address the respective device and specifying the command and value to be executed and set, respectively. As indicated above, a control device may function as a user-machine-interface generating the actual device command derived from the user's actions, such as selections on a GUI (Graphical User Interface) screen.

In response, the control adapter checks the device command and translates it into a message format the routing engine is able to interpret (arrow 402). Subsequently, the control adapter holds the translated message until it gets connected to the routing engine at a later point in time.

Regularly, the routing engine contacts the control adapter and queries whether or not there are one or more messages waiting to be processed (arrow 404), e.g., does the control adapter have a message to deliver. In case there is a message waiting, as assumed in the present scenario, the control adapter transmits the previously translated message to the routing engine in return to the routing engine's command (arrow 406). The routing engine now examines the message, in particular by reading out the control information, and performs a lookup to find the appropriate adapter where the message is to be sent (arrow 408). In a preferred embodiment, the control adapter encoded the respective device adapter as the addressee within the message header. In the following, the routing engine sends the message to the device adapter specified by the examined target address (arrow 410).

After having received the message, the device adapter translates the message into a format that can be processed by the device (arrow 412). In most cases the format may be formed by proprietary device control strings which might not even follow any commercial standard. However, since the device adapter is particularly configured to translate the received message in the format required by the device, basically any format may be supported. Then, the translated message, i.e., the device control string, is sent to the device (arrow 414). After sending the device control string to the device, the device adapter returns control back to the routing engine (arrow 416).

At a later point in time, the routing engine contacts the device adapter by querying, whether the device adapter has to deliver a message (arrow 422). In this case the device adapter translates the device state information into a message having a format the routing engine is able to interpret (arrow 424) and returns the message containing the ‘new’ device state information (arrow 426). In order to ensure, that the command was actually executed by the device, an additional query may be performed before returning the ‘new’ device state information. Advantageously, the additional query is employed if return information is available from the device after executing commands. Subsequently, the routing engine examines the message and performs a lookup to find the appropriate adapter the message has to be sent to (arrow 428). Since the device adapter has encoded the control adapter as the addressee within the message header, the routing engine is enabled to send the message to the respective control adapter (arrow 430).

Thereafter, the control adapter translates the message into specific Device Data, such as a XML-Message containing the actual temperature measured by a thermometer device and presents the message and data to the user and returns control back to the routing engine (arrow 432, 434, 436).

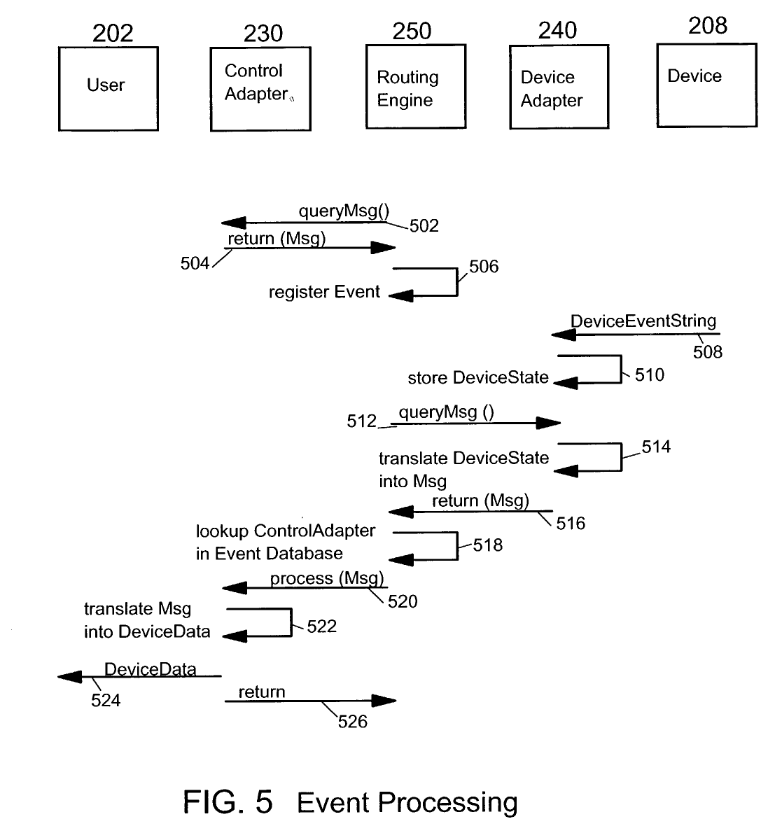

With reference now to FIG. 5, there is depicted a flowchart illustrating a method of registering events as well as processing events by the appliance in accordance with the present invention. In this scenario, the communication takes place between the user 202, the control adapter 230, 231, 232, the routing engine 250, one of the device adapters 240, 241, 242 and the respective device 208, 209, 210.

Whenever the control adapter wants to be notified by the routing engine in case of an event, the control adapter must previously register itself to the routing engine. In order to do so, the next time the control adapter is being queried by the routing engine (arrow 502), the control adapter sends a register event message (arrow 504). Then, the routing engine stores the event registration within a event database (arrow 506). The event database may be implemented as a part of the configuration data storage.

Whenever an event occurs, the device sends an event notification message to the device adapter (arrow 508). The event notification message may be in a particular proprietary format, such as a device event string, containing event information. The format may not follow any commercial standard. In the following, the device adapter that is particularly configured to deal with this format interprets the device event string and extracts device event information and the device state information from the device event string and stores such information (arrow 510). At a later point in time the routing engine contacts the device adapter by querying, whether or not there is a message available, e.g., whether or not the device adapter has a message to deliver (arrow 512).

In this case, the device adapter translates the device state information including event information into a message format the routing engine can interpret (arrow 514) and returns the translated information to the routing engine (arrow 516).

In return, the routing engine examines the message and performs a lookup to find the appropriate adapter where the message is to be sent (arrow 518). Since the device adapter has encoded the event identification within the message header, the routing engine is able to determine the control adapter by performing a lookup in the event database. Then the routing engine sends the message to the control adapter (arrow 520).

Thereafter, the control adapter translates the message into specific Device Data, such as a XML-Message containing the actual temperature measured by a thermometer device, presents the message and data to the user and returns control back to the routing engine (arrows 522 to 526).

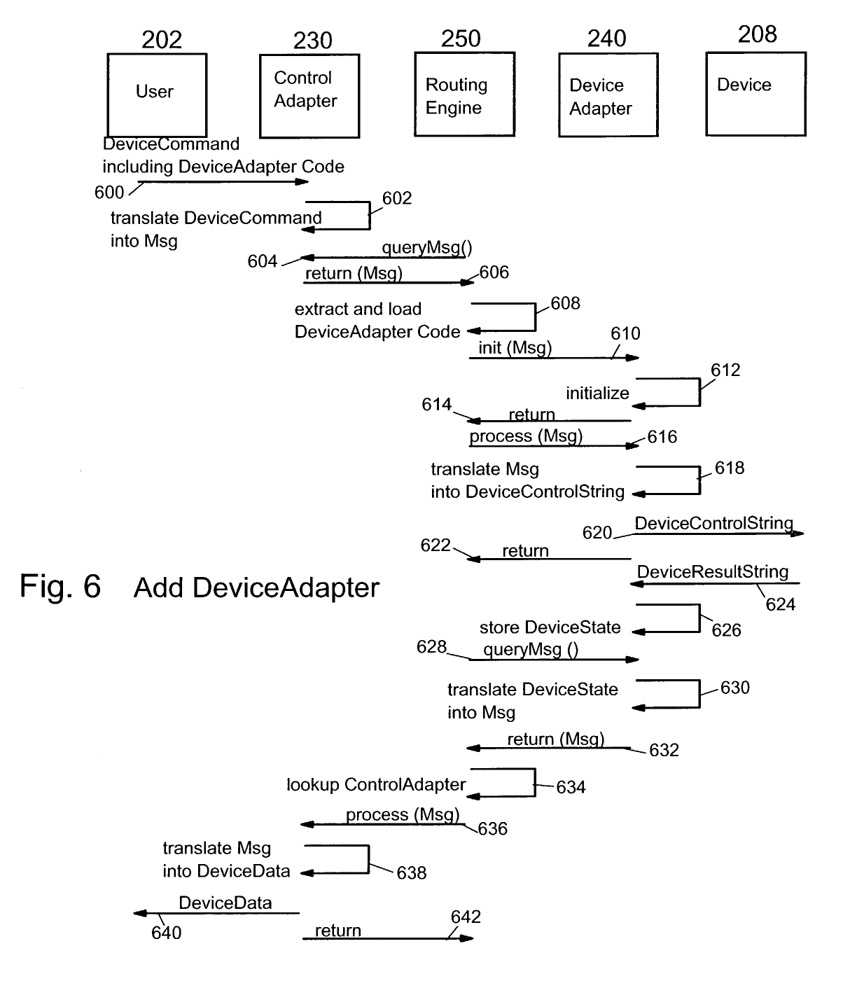

With reference now to FIG. 6, there is depicted a flowchart illustrating a method of adding a new device adapter in accordance with the present invention. In this scenario, the communication takes place between the user 202, one of the control adapters 230, 231, 232, the routing engine 250, one of the device adapters 240, 241, 242 and the respective device 208, 209, 210.

Whenever the user wants to add a new device adapter to the system, because a new device has previously been installed, contact is made to the control adapter by sending a device command containing a device adapter code (arrow 600). The device adapter code can be realized for example by archive files, e.g., JAVA.jar files. The control adapter now checks the device command and translates it into a message format the routing engine can interpret (arrow 602). In the following, the control adapter holds this message until, at a later point in time, it gets connected to the routing engine, i.e., a communication link between the control adapter and the routing engine gets established.

In the present example this is an add device adapter message. The routing engine processes this message in the following way: at a later point in time the routing engine contacts the control adapter by querying whether or not there is a message available, e.g., the control adapter has a message to deliver (arrow 604). If this is true, the control adapter returns the previously translated add device adapter message to the routing engine (arrow 606). The routing engine examines the message and extracts the device adapter code contained in the message (arrow 608). Then, the device adapter is loaded by the routing engine and an initialization message, which may also be extracted from the original add device adapter message, is sent to the new device adapter (arrow 610). After the device adapter has performed its initialization (arrow 612), a return message (arrow 614) is sent to the routing engine.

The routing engine optionally sends a query message to the device adapter (arrow 616). This query message may also be extracted from the add device adapter message. The device adapter now translates the message into a specific Device Control String (arrow 618) and then sends this data to the device (arrow 620). Then, the device adapter returns control back to the routing engine (arrow 622). Asynchronously, the device sends the requested values within a specific device result string (arrow 624). This additional, but optional, message has been added so the user is able to get data from this new device as a result of the successful device adapter initialization. This is much more efficient than merely informing the user, that the device adapter initialization has been occurred.

The device adapter then extracts the resulting device state information from the device result string and stores the state of the information (arrow 626). The next time the routing engine contacts the device adapter by querying, whether or not the device adapter has a message to deliver (arrow 628), the device adapter translates the device state information into a message format the routing engine can interpret (arrow 630) and returns it to the routing engine (arrow 632).

Subsequently, the routing engine examines the message and performs a lookup to find the appropriate adapter where the message is to be sent (arrow 634). Since the device adapter has encoded the control adapter as addressee within the message header, the routing engine sends the message to the control adapter (arrow 636).

The control adapter translates the message into specific Device Data, presents the message and data to the user and returns control back to the routing engine (arrow 638 to 642).

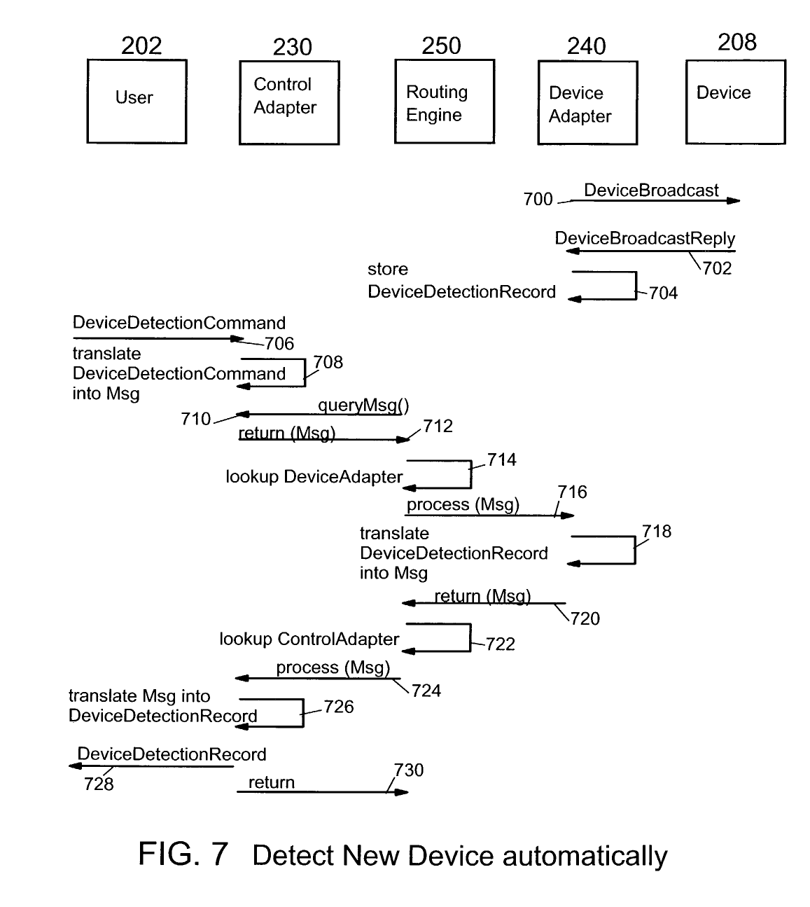

With reference now to FIG. 7, there is depicted a flowchart illustrating a method of detecting a device added to the network in accordance with the present invention. In this scenario, the communication takes place between the user 202, the control adapter 230, 231, 232, the routing engine 250, one of the device adapters 240, 241, 242 and the new device 208, 209, 210. In this case, the device adapter is not logically connected to one specific device. Instead the device adapter is a device detection adapter and it broadcasts a specific signal (arrow 700), namely the device broadcast signal, within its communication protocol to all devices connected via this protocol.

Only devices, which are not already logically connected to a specific device adapter have to respond to this signal by sending a device broadcast reply (arrow 702). So, whenever a user adds a new device to the network, the device responds to the device broadcast issued by the device adapter. Then the device adapter extracts the appropriate data from the device broadcast reply and stores a device detection record (arrow 704). The device broadcast as well as the device broadcast reply may be formed by proprietary data formats, whereas the device detection record may be implemented as in an XML document.

Whenever the user wants to query, in case a new device has been detected, contact is made to the control adapter by sending a device detection command containing the query (arrow 706), whereby a device detection command may, for example, be represented by an XML document. The control adapter now checks the device detection command and translates it into a message format the routing engine can interpret (arrow 708). This case is a query detection records message, which is held by the control adapter, until it is contacted by the routing engine at a later point in time.

The routing engine then processes the query detection records message in the following way: the routing engine contacts the control adapter by querying, whether or not there is a message available, e.g. the control adapter has a message to deliver (arrow 710). If yes, the control adapter returns the previously translated query detection records message to the routing engine (arrow 712). The routing engine now examines the message and performs a lookup to find all the appropriate adapters, which can handle this kind of message (arrow 714). This type of device adapter is referred to as a detection device adapter. The routing engine then sends the message to the device adapter (arrow 716). Subsequently, the device adapter translates the device detection record into a message format that the routing engine can interpret (arrow 718) and returns the message to the routing engine (arrow 720). Then, the routing engine examines the message and performs a lookup to find the appropriate adapter where the message is to be sent (arrow 722). Since the device adapter has encoded the control adapter as addressee within the message header, the routing engine is enabled to send the message to the respective control adapter (arrow 724).

In the following process steps, the control adapter translates the message back into the specific device detection record, presents it to the user and returns control back to the routing engine (arrows 726, 728, 730). So the user is able to select the appropriate data from the Device Detection Record, such as Device Manufacturer and Model and then can send the appropriate device command including the appropriate Device Adapter Code (see FIG. 6).

The present invention can be realized in hardware, software, or a combination of hardware and software. Any kind of computer system, or other apparatus adapted for carrying out the methods described herein, is suitable to implement the present invention. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system, is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

Although certain preferred embodiments have been shown and described, it should be understood that many changes and modifications may be made therein without departing from the scope of the appended claims.

1. An apparatus for facilitating communication between a user interface and one or more external devices each capable of having a distinct communication protocol, the apparatus comprising:
at least one control adapter for transforming a particular communication protocol established between said user interface and said at least one control adapter into a common message format;
one or more device adapters for transforming said distinct communication protocol established between one of said external devices and a respective one of said device adapters into said common message format; and
a routing engine for routing said common format messages between a designated one of said control adapters and an appropriate one of said device adapters.

2. The apparatus according to claim 1, further comprising a configuration data storage for holding configuration data.

3. The apparatus according to claim 1, wherein each of said control adapters is configured to manage a control state that is kept in a control state storage included in each of said control adapters.

4. The apparatus according to claim 3, wherein each of said device adapters is configured to manage a device state that is kept in a device state storage at least one being provided in each of said device adapters.

5. The apparatus according to claim 5, wherein the apparatus is being be configured to facilitate one of an additional device adapter and an additional control adapter which are retrieved from an external data source.

6. A method for facilitating communication between at least one user interface and one or more external devices, said user interface having a communication link to a control adapter and said external device having a communication link to a device adapter, both said control adapter and said device adapter being in communication with a routing engine, the method comprising the steps of:
receiving from said user interface a device command for controlling said external device;
translating, by said control adapter, said device command into a message having a format interpretable by said routing engine;
said routing engine receiving said message, determining the appropriate device adapter and sending said message to said device adapter;
said device adapter translating said message into a device control string having a format that can be processed by said device; and
sending said device control string to said device.

7. The method according to claim 6, further comprising the steps of:
said device adapter receiving from said device, information about the results of a previously executed command; and
said device adapter storing said information.

8. The method according to claim 6, further comprising the steps of:
said device adapter receiving from said routing engine a query for information about the status of said device; and
said device adapter translating said information into a format that can be processed by said routing engine and returning said information to said routing engine.

9. The method according to claim 8, further comprising the steps of:
said routing engine looking up said appropriate control adapter to receive said information; and
forwarding said information to said control adapter.

10. The method according to claim 9, further comprising the steps of:
said control adapter translating said information into a format that can be processed by said user interface and returning said information to said user interface.

11. The method according to claim 6, wherein the step of receiving from said user interface a command for controlling said external device includes the step of receiving a command for registering a specified event of said device, and further comprising the step of storing the registration of said specified event in an event database.

12. The method according to claim 11, further comprising the steps of:
said control adapter receiving, via said device adapter and said routing engine, from said device a notification about an occurrence of an event;
said control adapter looking up the registration for said event in said event database; and
notifying said user interface about the occurrence of said event, if said event is registered in said event database.

13. The method according to claim 6, wherein the step of receiving from said user interface a command for controlling said external device includes the step of receiving device adapter code for adding a new device adapter to said apparatus.

14. The method according to claim 6, wherein the step of receiving from said user interface a command for controlling said external device includes the step of receiving a device detection command for automatically adding a new device adapter to said apparatus.

15. The method according to claim 14, further comprising the steps of:
said device adapter sending a broadcast message for retrieving information from a new device;
said device adapter retrieving information from said new device and storing said information.

16. A computer program product implemented by the execution of computer instructions stored on a computer readable media for facilitating communication between at least one user interface and one or more external devices, said user interface having a communication link to a control adapter and said external device having a communication link to a device adapter, both said control adapter and said device adapter being in communication with a routing engine, the computer program product including instructions comprising:
program means for receiving from said user interface a device command for controlling said external device;
program means for translating, by said control adapter, said device command into a message having a format interpretable by said routing engine;
program means for receiving said message, by said routing engine and for determining the appropriate device adapter and sending said message to said device adapter;
program means for translating by said control adapter said message into a device control string having a format that can be processed by said device; and
program means for sending said device control string to said device.

17. An apparatus for facilitating communication between at least one user interface and one or more home network devices for controlling environmental conditions, each said home network device being capable of having a distinct communication protocol, comprising:
a control adapter that receives a device command from said user interface for controlling said home network device, and translates said device command into a common format message;
a device adapter for translating said common format message into a device control string having one of said distinct communication protocols that can be processed by said home network device;
a routing engine for receiving said common format message from said control adapter, and for sending said common format message to an appropriate device adapter;
wherein said device control string is sent to said home network device such that said environmental conditions are controlled by said home network devices in accordance with said device command from said user interface.

18. The apparatus according to claim 17, wherein said device adapter receives and stores information from said home network device regarding the results of a previously executed command.

19. The apparatus according to claim 17, wherein said device adapter comprises:
means for receiving from said routing engine a query for information about a status of said home network device;
means for translating said information into said common format message that can be processed by said routing engine; and
means for returning said information to said routing engine.

20. The apparatus according to claim 19, wherein said routing engine comprises:
means for determining an appropriate one of said control adapters to receive said information from said home network device; and
means for forwarding said information to said appropriate control adapter.

21. The apparatus according to claim 20 wherein said control adapter comprises:
means for translating said information from said common format message into a user format that can be processed by said user interface; and
means for returning said information to said user interface.

22. The apparatus according to claim 17, wherein said control adapter receives and stores a command from said user interface for registering a specified event of said device.

23. The apparatus according to claim 22, wherein said control adapter further comprises:
means for receiving, via said device adapter and said routing engine, from said home network device a notification about an occurrence of an event;
means for determining the registration for said event in said event database; and
means for notifying said user interface about the occurrence of said event when said event is registered in said event database.

24. The apparatus according to claim 17, wherein said control adapter receives from said user interface device adapter code for adding a new device adapter to said apparatus to operate in connection with a new home network device.

25. The apparatus according to claim 17, wherein said control adapter receives from said user interface a command a device detection command for automatically adding a new device adapter to said apparatus to operate in connection with a new home network device.

26. The apparatus according to claim 25, wherein said device adapter sends a broadcast message to retrieve and store information from said new home network device.

27. The apparatus according to claim 17 wherein the home network device controls at least one kitchen appliance.

28. The apparatus according to claim 17 wherein the home network device controls at least one electronic device.

29. The apparatus according to claim 17 wherein the home network device controls an environmental control unit.
